(19) United States
(12) Patent Application Publication
(10) Pub. No.: US 2006/0074798 A1
(43) Pub. Date: Apr. 6, 2006

(54) Financial instrument, system, and method for electronic commerce transactions

(76) Inventors: Khaja Mohi-ud Din, Madison, WI (US); Ahmed Naveed Fazil, Mount Prospect, IL (US)

Correspondence Address: FOLEY & LARDNER LLP, 150 EAST GILMAN STREET, P.O. BOX 1497, MADISON, WI, 53701-1497, US

(21) Appl. No.: 10/972,736

(22) Filed: Oct. 25, 2004

Related U.S. Application Data
(60) Provisional application No. 60/613,259, filed on Sep. 27, 2004.
(60) Provisional application No. 60/615,667, filed on Oct. 4, 2004.

(51) Int. Cl. G06Q 40/00

(52) U.S. Cl. 705/39

(57) ABSTRACT

A financial instrument for limited use with electronic commercial transactions corresponds to a subordinate account with a financial institution, where the instrument and the subordinate account has a randomly-selected or a generated name, an assigned number, and a pre-defined billing address. The financial instrument can be used for on-line transactions without fear of identity theft because the account holder's true identity is not associated with the subordinate account but rather with an account related to the subordinate account.

### CROSS REFERENCE TO RELATED APPLICATIONS

The present application claims priority to U.S. Provisional Patent Application 60/613,259 entitled “A KNEW METHOD OF SAFEGUARDING THE PRIVACY AND IDENTITY OF CUSTOMERS IN PRIMARILY NON FACE TO FACE TRANSACTIONS WHERE THE METHOD OF PAYMENT IS A CREDIT AND/OR DEBIT CARD” filed on Sep. 27, 2004, and U.S. Provisional Patent Application 60/615,667 entitled “NEW METHOD OF SAFEGUARDING THE PRIVACY AND/OR IDENTITY AND/OR THE CARD NUMBER OF CUSTOMERS IN PRIMARILY NON-FACE-TO-FACE TRANSACTIONS WHERE THE METHOD OF PAYMENT IS CURRENTLY A CREDIT AND/OR DEBIT CARD” filed on Oct. 4, 2004, the contents of which are incorporated herein by reference in their entirety.

### BACKGROUND OF THE INVENTION

1. Field of the Invention

The present invention relates generally to financial instruments and payment systems. More particularly, the present invention relates to a financial instrument, system, and method for electronic or telephony commerce transactions.

2. Description of the Related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

The Internet has facilitated commercial transactions by making products and services available to millions of potential customers via electronic means, such as computers coupled to other computers via a network. Electronic commerce transactions over the Internet benefit from increased ease and convenience. At the same time, though, such transactions provide opportunities for fraudulent behavior, such as identity theft, misuse of customer data or information and credit card fraud.

Prior attempts to make electronic commerce transactions less susceptible to illegal conduct have taken many forms. For example, specialized credit, debit, and payment cards have been proposed, such as the card described by Wong et al. in U.S. Pat. No. 6,592,044 for example, and the card described by Walker et al. in U.S. Pat. No. 6,163,771. Computer software solutions, such as digital wallets, biometric devices and other mechanisms have also been proposed.

All of these prior attempts to improve on electronic commerce suffer from the fact that they are susceptible to identity theft. Credit card transactions on the Internet generally require the customer to enter an account number, card expiration date, account holder name, and a billing address. This account and personal information can be valuable. A variety of schemes have been utilized to illegally capture or obtain the personal information and/or the account information. Some transactions require a security or verification number, which is usually printed on the reverse of a credit or debit card or, in the case of some American Express cards, printed in non-raised letters on the front of the card. The card described by Wong et al. displays a different number on an LCD screen on the face of the card for every new transaction.

These prior attempts to improve electronic commerce cannot use fictitious names, as suggested by Wong et al. without violating legal requirements, such as the Patriot Act or Sarbanes-Oxley regulations. The Patriot Act, for example, requires that account holder information be discernable by the financial institution such that money laundering, funding of terrorist organizations or efforts, and other illegal activities can be identified and traced. The solution of Wong et al. described in U.S. Pat. No. 6,592,044 was conceived and filed before Sep. 11, 2001, and specifically calls for a fictitious name and proxy agent's address to be coded in the magnetic strip and/or proprietary hardware and software embedded on a physical credit card type instrument which would allow for persons to procure goods and services in either electronic or face to face transactions without revealing their true identity to the vendor or service provider. However, such a solution thwarts homeland security measures. While the solution described by Wong et al. may or may not currently break the law, it does put issuing financial institutions and service providers' reputations at risk. Moreover, the solution posited by Wong et al. does not take homeland security measures into consideration and may facilitate evasion of these now monitored transactions.

As a result of these legal requirements and for good business reasons, a credit card company or a financial institution, such as a bank or credit union, will not (and cannot) permit someone to open an account under a fictitious name or alias. The financial institution must have multiple, government-issued identification, of which one must be a photograph bearing identification such as a passport or a driver's license, and a social security number and/or card, to link a true identity to the account. These requirements are referred to as Know Your Customer (KYC). Financial institutions must by law employ the KYC processes to assure that accounts are opened by bone fide individuals who are who they claim to be.

There is a need for a way to improve electronic commerce transactions. Further, there is a need to eliminate or significantly reduce identity theft. The present application describes a solution to the problems of identity theft and some account fraud while at the same time satisfying the business and legal requirements associated with having anti-money laundering (AML), anti-terrorist financing and other compliance monitoring of an account held with a financial institution.

### SUMMARY OF THE INVENTION

In general, the present invention relates to a financial instrument and a financial or barter transaction methodology for limited use with non-face-to-face electronic commercial transactions. The financial instrument can be referred to as an Internet Procurement Credential (IPC). The IPC can be virtual in nature and can reside on any current media such as paper, plastic cards, electronic media or any other form of storage device. The IPC corresponds to a subordinate bank, credit card or any other form of depository or credit account held with a financial institution which is linked to a known named account and/or person. The IPC account can include an account number or credential number to simulate a card transaction, an Account Verification Number (for example, a number between 3 to 6 digits), four digits to represent the last four digits of a social security number, a randomly-selected or generated name (or identifier such as an assigned number) and a pre-defined billing address. The IPC may also contain an additional set of numbers representative of a depository account to enable the simulation of a check transaction. The execution of the IPC on a non-face-to-face transaction can be referred to as a Masked Identity Transaction (MIT). The IPC can be used for on-line transactions without fear of identity theft because the account holder's true identity (or details) is not associated with the subordinate account but rather with another account to which the IPC account is subordinated. MITs can replace any credit card, or check type transaction conducted over an electronic or voice media.

An IPC or MIT that is created or generated by a third party can reside on any media including a browser, any computational device, PDA, telephony device that can connect or link to any existing depository or credit account including electronic wallets or electronic vault. In at least one exemplary embodiment, the IPC is not created or controlled by the financial institution where the depository or credit account exists rather it is created and administered by a third party. Under these circumstances, there need not be a subordinate account. Instead of a subordinate account, there are two complete financial transactions where the consumer utilizes the IPC to execute an MIT over the Internet. The IPC submits a payment request to the consumers actual account. Once the funds are confirmed or transferred to the electronic wallet associated with the IPC or the IPC issuer, or third party, the merchant is paid.

One exemplary embodiment relates to a financial instrument for use with electronic commercial transactions. The financial instrument includes an assigned number associated with a procurement credential account in which the procurement credential account is associated with an individual. The financial instrument further includes a generated name that is different than an actual name of the individual. The procurement credential account has an inextricable association with a separate account which includes the actual name of the individual.

Another exemplary embodiment relates to a method of procurement using a credential associated with a first account that does not have true identification for an account holder but is associated with a second account that has true identification for the account holder. The method includes receiving information regarding a procurement credential of an account over a network. The procurement credential has at least an account number and a name, the name being a fictitious name unrelated to an actual name of an account holder of the account. The method further includes verifying the procurement credential for the account utilizing the received information where the account is associated with a second account having the true identification for the account holder. The method includes consummating a transaction upon receiving verification of the procurement credential.

Another exemplary embodiment relates to a method of making a purchase over the Internet using a procurement credential associated with a first account that does not have true identification for an account holder but is associated with a second account that has true identification for the account holder. The method includes requesting payment for a transaction over the Internet, receiving at least an account identifier for a procurement credential, verifying the procurement credential utilizing the account identifier, and finalizing payment for the transaction upon receiving verification of the procurement credential. In the method, the account identifier for the procurement credential does not include a true identity of an account holder and the procurement credential is associated with a second account having the true identification for the account holder.

Another exemplary embodiment relates to a system for making a purchase over a network using a procurement credential associated with a first account that does not have true identification for an account holder but is associated with a second account that has true identification for the account holder. The system includes means for receiving at least an account identifier for a procurement credential in response to a request for payment for a transaction, means for verifying the procurement credential utilizing the account identifier, and means for finalizing payment for the transaction upon receiving verification of the procurement credential. The account identifier for the procurement credential does not include a true identity of an account holder. The procurement credential is associated with a second account having the true identification for the account holder.

Another exemplary embodiment relates to a system for making a purchase over a network using a procurement credential associated with a first account that does not have true identification for an account holder but is associated with a second account that has true identification for the account holder. The system includes a first account associated with a procurement credential and a second account associated with the first account. Neither first account nor the procurement credential has a true identity for an account holder. The second account includes the true identity for the account holder of the first account.

### BRIEF DESCRIPTION OF DRAWINGS

FIG. 1 is a general diagram depicting a front and back of a card with an account number and generated name in accordance with an exemplary embodiment.

FIG. 2 is a diagram of an account and a subordinate or Internet Procurement Credential (IPC) account in accordance with an exemplary embodiment.

FIG. 3 is a diagram depicting a standard Masked Identity Transaction (MIT) in accordance with an exemplary embodiment.

FIG. 4 is a diagram of a process of obtaining an Internet Procurement Credential (IPC) and using the IPC to conduct commerce without threat of identity theft in accordance with an exemplary embodiment.

FIG. 5 is a diagram depicting the creation and management of an Internet Procurement Credential (IPC) by a third party in accordance with an exemplary embodiment.

FIG. 6 is a flow diagram depicting operations performed in an exemplary transaction involving the IPC of FIG. 5.

### DETAILED DESCRIPTION OF EXEMPLARY EMBODIMENTS

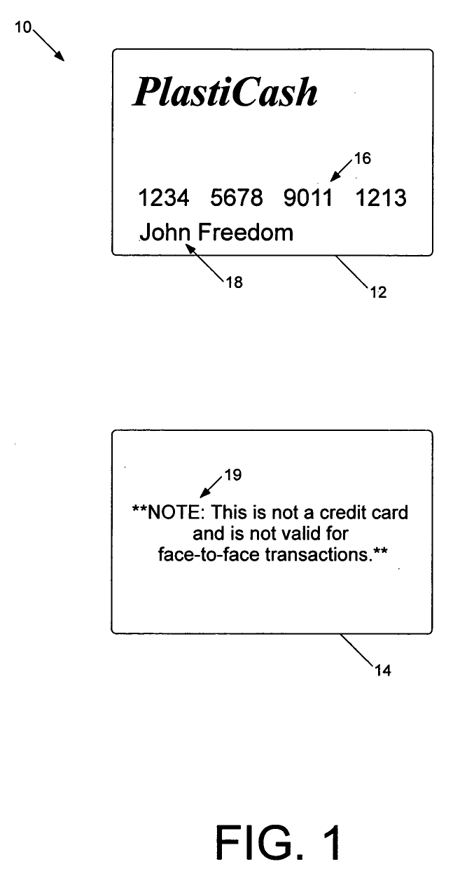

FIG. 1 illustrates an Internet Procurement Credential (IPC) in the form of a plastic card 10 issued to a consumer. The card 10 includes a front 12 and a back 14. The card 10 is an instance of the physical manifestation of an IPC issued by a financial or third party institution. In an exemplary embodiment, the IPC is associated with a first account which is associated with a second account at the same financial institution. The association between the accounts is known by the financial institution and the customer. The front 12 of the card 10 includes an assigned number 16 and a name 18 that is different than the customer's name. The name 18 can be generated by a computer algorithm or randomly assigned. The name 18 can be a generic name, such as John Freedom or John Smith. This generic name can be the same for all users of the card or a subset of users of the card. Alternatively, the name 18 can completely random, such that it appears to be non-sense to the reader (e.g., Rpklw Wzkqwtp).

In at least one exemplary embodiment, the back 14 can include a disclaimer that informs merchants that the card 10 is not a credit, debit, or payment card and cannot be used in face-to-face transactions. Preferably, the back 14 does not include a magnetic strip characteristic to commonly used cards as a means to further notify merchants that the card 10 is not a credit, debit, or payment card but instead is an IPC representation. Further, according to an exemplary embodiment, the account associated with the assigned number 16 and name 18 is limited in its use to transactions not requiring a true identity or identity verification. For example, the card 10 could not be used to purchase airline tickets where the ticketed passenger name must match government-issued identification. Similarly, the card 10 could not be used to pay for hotel or lodging arrangements where the credit card must match identification.

In alternative embodiments, the card 10 can include a computer chip, a liquid crystal display (LCD), a bar code, or other structure for identification, verification, or other credit card fraud prevention measures. In further alternative embodiments, the card 10 can be instantiated by software as an electronic wallet or a digital certificate.

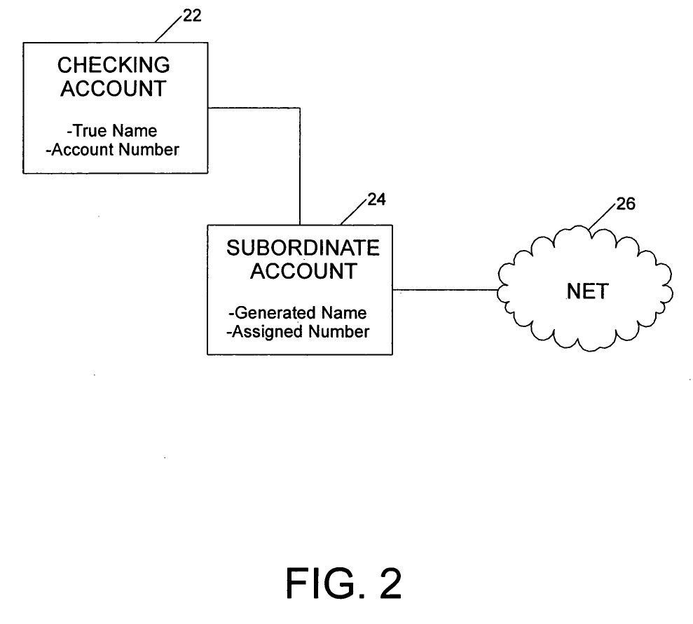

FIG. 2 illustrates a checking account 22 with an institution, such as a bank or credit union. The checking account 22 includes information regarding the identity of the account holder, referred to as the account holder's “true name.” A subordinate account 24 is created that is associated with the checking account 22. This association includes the ability for funds to be transferred between the checking account 22 and the subordinate account 24. The association between the checking account 22 and the subordinate account 24 cannot be severed. It is inextricable. The subordinate account 24 includes a contrived (random or assigned/sensible or nonsensical/representative or numerical) identity or a name mask generated randomly or purposefully as an alias to cloak the true identity of the holder of the checking or credit account 22. The subordinate account 24 also includes an assigned number that functions as the account number.

The subordinate account 24 can be accessed from a network 26, such as the Internet, to access funds. For example, a purchase can be made on a web site using the subordinate account 24 where the customer enters the contrived name, the subordinate account number, and a billing address established by the institution hosting the subordinate account 24. The web site can verify the account information, including the contrived name and authorize the transaction to be consummated.

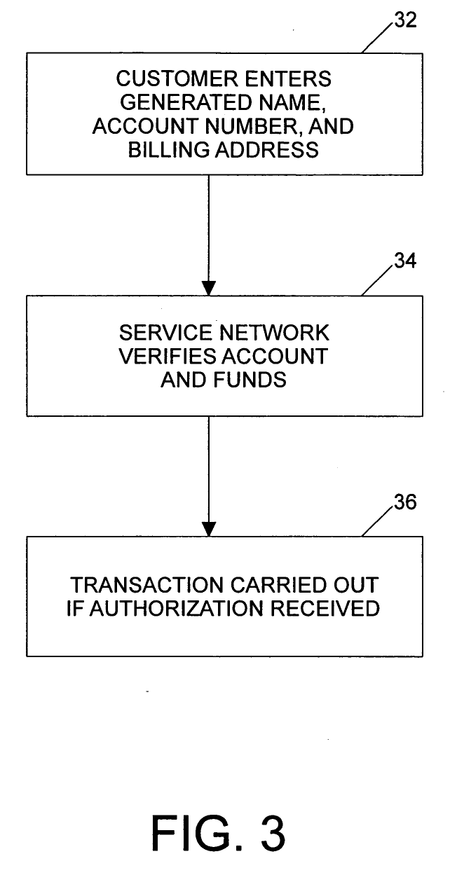

FIG. 3 illustrates operations in a process in which a subordinate account is used for an on-line transaction. Additional, fewer, or different operations may be performed in the process, depending on the particular embodiment. In an operation 32, the customer enters the generated name that is different from the customer's actual name, the subordinate account number, and billing address set by the institution servicing the subordinate account. In an operation 34, a payment service network, such as the VISA or MASTERCARD payment service network, verifies the account information and sufficiency of funds.

In an operation 36, the transaction is carried out if an authorization is received. As a result, the transaction is completed without the customer's true identity being communicated or made available. At the same time, a government entity, such as the Department of Homeland Security, can determine upon legal authorization the true owner of the subordinate account, Internet Procurement Credential or Identity Mask from the institution servicing the subordinate account, who knows the identity of the customer from the associated account, such as a checking account.

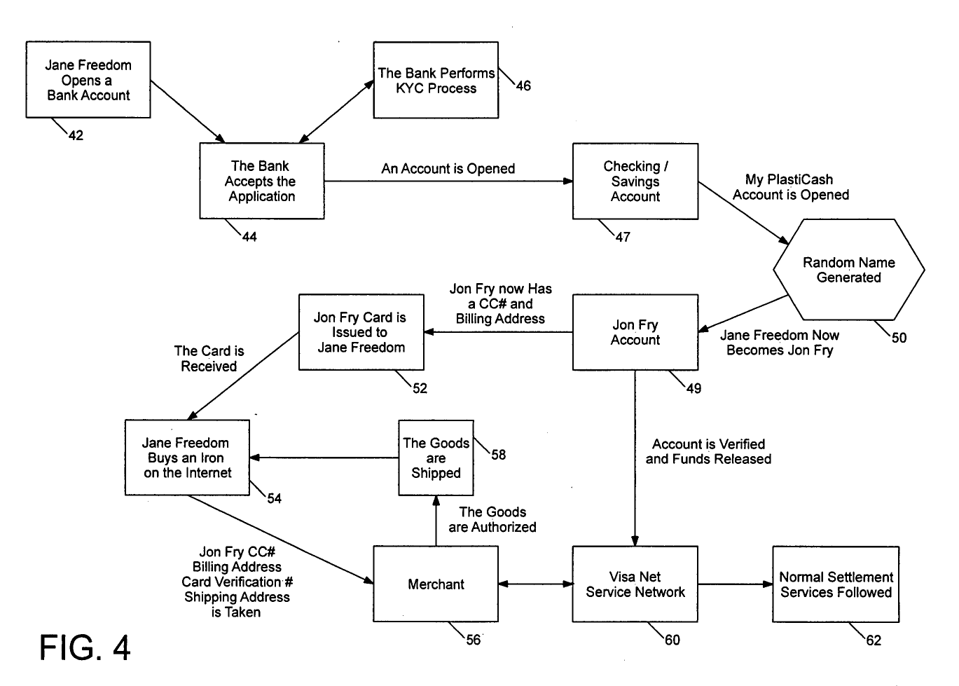

FIG. 4 illustrates a process of obtaining a subordinate account and using the subordinate account to conduct commerce without threat of identity theft. Additional, fewer, or different operations may be performed in the process, depending on the particular embodiment. In an operation 42, an individual named Jane Freedom opens a bank account. The bank account can be any of a variety of accounts available at a bank. The bank account requires Jane's true and correct identity.

In an operation 44, the bank accepts the application for the bank account having performed a know your customer (KYC) process in an operation 46 to confirm the identity provided by Jane is correct. The KYC process is required of the bank by law. Once a checking or savings account 47 is opened, Jane Freedom can open a second account 49. The second account 49 includes a name or identity that is randomly generated in an operation 50. This generated name is Jon Fry, as an example.

In an operation 52, a Jon Fry Internet Procurement Credential is issued to Jane Freedom. Using the Jon Fry Credential, Jane Freedom purchases an iron on the Internet in an operation 54 from a merchant 56. The merchant 56 receives Jon Fry's name, the card number, a verification number, billing address, and shipping address. In at least one embodiment, the billing address is an address established by the credential issuing institution. This established address can be one of a number of physical locations owned by the credential issuing institution. The shipping address is Jane Freedom's address so that the iron she purchases will be delivered to her in an operation 58.

The merchant 56 carries out the purchase transaction using a service network 60. The service network 60 verifies the account and fimds are released to be credited to an account of the merchant 56 following settlement services 62. As a result, Jane Freedom can purchase from a merchant on the Internet without communicating her true identity to the merchant. If the Jon Fry name and account are stolen, Jane Freedom closes the account and does not have to worry about identity theft issues. In at least one embodiment, the bank can notify Jane Freedom with an email communication, text message, and/or voice message or other commonly agreed method of communication every time the Jon Fry card is used. In this way, Jane can easily detect when the Jon Fry account is being used without her permission.

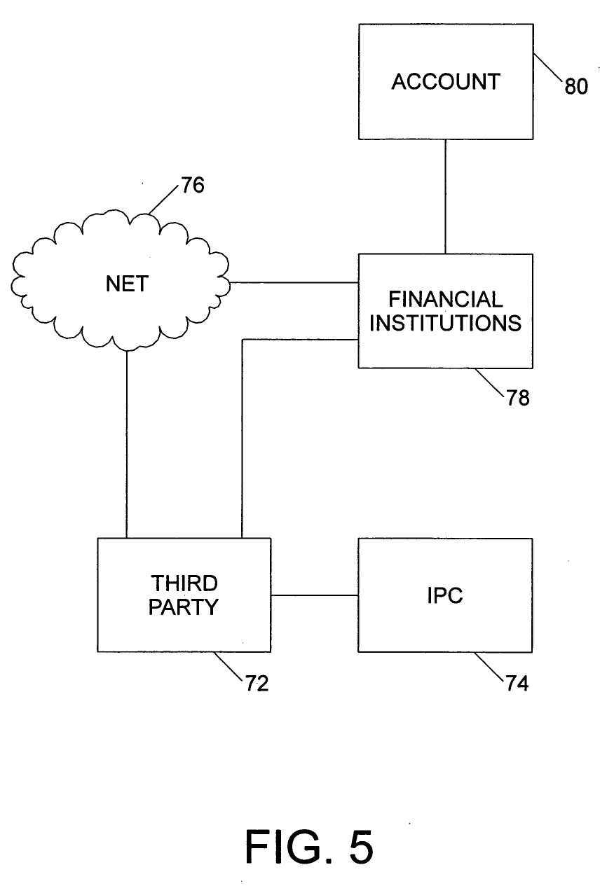

FIG. 5 illustrates a third party 72 that creates and manages an Internet Procurement Credential (IPC) account 74. The IPC account 74 can be accessed via a network 76, such as the Internet, by vendors to consummate financial transactions with customers. The IPC account 74 can be identified by an account number and a account holder name, which is different than the customer's actual name. The third party 72 knows that the name used for identification purposes is not the actual true identification of the customer. The third party 72 also knows the true identity of the customer and associates the IPC account with a financial institution 78 where the customer has an account 80.

An identifier of the IPC account 74 that is created or generated by a third party can reside on any media including a browser, any computational device, PDA, telephony device that can connect or link to any existing depository or credit account including electronic wallets or electronic vault. In the situation where the IPC account 74 is not created or controlled by the financial institution 78 where the depository or credit account 80 exists, but rather it is created and administered by a third party, there need not be a subordinate account as described with reference to FIGS. 1-4. Instead of a subordinate account, there are two complete financial transactions where the consumer utilizes the IPC account 74 to execute a Masked Identity Transaction (MIT) over the Internet. The third party 72 managing the IPC account 74 submits a payment request to the consumer's actual account. Once the funds are confirmed or transferred to the electronic wallet associated with the IPC account 74 or the IPC issuer, or third party 72, the merchant is paid.

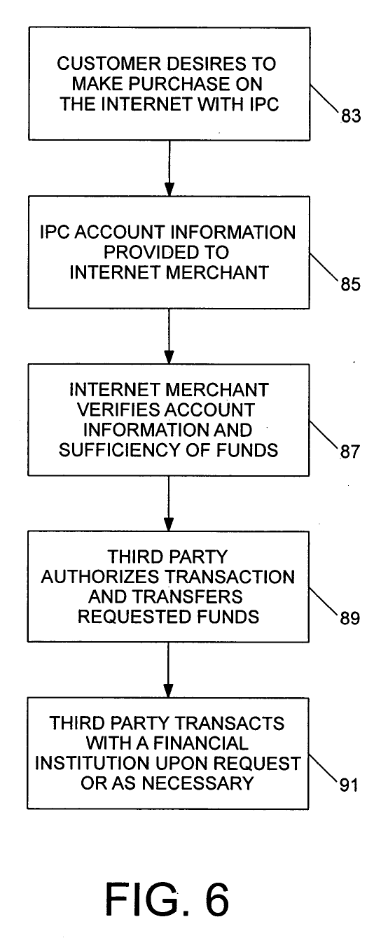

FIG. 6 illustrates a flow diagram depicting operations performed in an exemplary transaction involving the IPC account of FIG. 5. Additional, fewer, or different operations may be performed, depending on the embodiment. In an operation 83, a customer desires to make a purchase on the Internet with an Internet Procurement Credential (IPC). The EPC can be instantiated in a file stored in the customer's computer, the IPC can be represented by numbers on a physical card held by the customer, or the IPC account information can be known or memorized by the customer.

In an operation 85, the EPC account information is provided by some means to the Internet merchant from whom the customer desires to purchase goods or services. The IPC account information can be provided to the Internet merchant in a variety of ways, including-as discussed above-electronically via a software cookie or manually by the customer typing account information into a form on the Internet merchant's web site. The IPC account information can include an account name (which is different than the customer's real name), an account number, and an account billing address. In at least one embodiment, the account billing address is the same for all IPC accounts managed by a third party. Alternatively, the account billing address differs depending on the region or city where the customer is located. The billing address is preferably not the actual billing address of the customer, although the customer can enter his or her actual address for the shipping address where the goods or services are to be received.

In an operation 87, the Internet merchant verifies account information from the IPC account information provided to it as well as the sufficiency of funds available to the account. This verification process preferably utilizes existing channels and services for account verification. In an operation 89, the third party authorizes the transaction and transfers the requested funds, if the IPC account has sufficient funds.

In an operation 91, the third party transacts with a financial institution with whom the customer has an account. This transaction can be made upon the request of the customer to replenish finds in the IPC account. This transaction could also be done automatically upon certain pre-established conditions. According to an exemplary embodiment, the third party and financial institution have an agreement or arrangement that the existence of the IPC account with the third party depends on the existence and association of that IPC account with an account with the financial institution. For example, if a customer were to open an IPC account with the third party based on an account with a financial institution and subsequently the customer closes the account without closing the IPC account, the financial institution would inform the third party of this activity and the IPC account would be frozen or made inactive.

The IPC account has the advantage of not including identity information that can be obtained (identity theft) and used fraudulently. As a person of skill in the art would appreciate, there are transactions that could not be accepted by a financial institution or a third party managing an IPC account because the transaction requires true identification. For example, as mentioned above, the IPC account may not be valid for purchasing tickets for travel or lodging, if legally or for business reasons, the true identity is necessary.

While several embodiments of the invention have been described, it is to be understood that modifications and changes will occur to those skilled in the art to which the invention pertains. For example, the institution creating the subordinate account may not even issue a card with the contrived name and account number. The Internet Procurement Credential may reside on a PDA, on an Internet Browser, on a laptop or desktop, on an email and/or other electronic media. Accordingly, the claims appended to this specification are intended to define the invention precisely.

1. A financial instrument for use with electronic commercial transactions, the financial instrument comprising:
an assigned number associated with a procurement credential account, wherein the procurement credential account is associated with an individual; and
a generated name that is different than an actual name of the individual, wherein the procurement credential account has an inextricable association with a separate account which includes the actual name of the individual.

2. The financial instrument of claim 1, wherein the separate account and the procurement credential account are maintained by a common institution.

3. The financial instrument of claim 1, wherein the separate account and the procurement credential account are maintained by separate entities.

4. The financial instrument of claim 1, wherein the generated name is randomly generated by a computer algorithm.

5. The financial instrument of claim 1, wherein the procurement credential account is valid for non-face-to-face transactions.

6. The financial instrument of claim 5, wherein the non-face-to-face transactions are Internet purchases.

7. The financial instrument of claim 1, further comprising a billing address that is different than an actual address of the individual.

8. The financial instrument of claim 7, wherein the billing address is an address for a third party service company.

9. The financial instrument of claim 1, wherein the assigned number and generated name reside in a media.

10. The financial instrument of claim 9, wherein the media can include any one of paper, plastic cards, electronic media, and any storage device.

11. The financial instrument of claim 1, further comprising an account verification number.

12. The financial instrument of claim 1, further comprising a depository account number that enables simulation of a check transaction using the procurement credential account.

13. The financial instrument of claim 1, wherein the procurement credential account is linked to an existing credit account.

14. A method of procurement using a credential associated with a first account that does not have true identification for an account holder but is associated with a second account that has true identification for the account holder, the method comprising:
receiving information regarding a procurement credential of an account over a network, the procurement credential having at least an account number and a name, the name being a fictitious name unrelated to an actual name of an account holder of the account;
verifying the procurement credential for the account utilizing the received information, wherein the account is associated with a second account having the true identification for the account holder; and
consummating a transaction upon receiving verification of the procurement credential.

15. The method of claim 14, wherein verifying the procurement credential comprises communicating with a third party service provider that services the account.

16. The method of claim 15, wherein a different institution than the third party service provider services the second account.

17. The method of claim 14, wherein the information regarding the procurement credential is stored in software.

18. A method of making a purchase over the Internet using a procurement credential associated with a first account that does not have true identification for an account holder but is associated with a second account that has true identification for the account holder, the method comprising:
requesting payment for a transaction over the Internet;
receiving at least an account identifier for a procurement credential, wherein the account identifier for the procurement credential does not include a true identity of an account holder;
verifying the procurement credential utilizing the account identifier, wherein the procurement credential is associated with a second account having the true identification for the account holder; and
finalizing payment for the transaction upon receiving verification of the procurement credential.

19. The method of claim 18, wherein the account identifier includes a fictitious name generated to mask the true identity of the account holder.

20. The method of claim 19, wherein the fictitious name is a generic name with no relation to the true identity of the account holder.

21. The method of claim 19, wherein the fictitious name is randomly generated using a computer algorithm.

22. The method of claim 20, further comprising receiving a billing address and an authorization number for the procurement credential.

23. A system for making a purchase over a network using a procurement credential associated with a first account that does not have true identification for an account holder but is associated with a second account that has true identification for the account holder, the system comprising:
means for receiving at least an account identifier for a procurement credential in response to a request for payment for a transaction, wherein the account identifier for the procurement credential does not include a true identity of an account holder;
means for verifying the procurement credential utilizing the account identifier, wherein the procurement credential is associated with a second account having the true identification for the account holder; and
means for finalizing payment for the transaction upon receiving verification of the procurement credential.

24. The system of claim 23, wherein the account identifier includes a fictitious name generated to mask the true identity of the account holder.

25. The system of claim 24, wherein the fictitious name is a generic name with no relation to the true identity of the account holder.

26. The system of claim 23, wherein the fictitious name is randomly generated using a computer algorithm.

27. A system for making a purchase over a network using a procurement credential associated with a first account that does not have true identification for an account holder but is associated with a second account that has true identification for the account holder, the system comprising:
a first account associated with a procurement credential, wherein neither the first account nor the procurement credential has a true identity for an account holder; and
a second account associated with the first account, wherein the second account includes the true identity for the account holder of the first account.

28. The system of claim 27, wherein the first account is maintained by a service provider and the second account is maintained by a different provider.

29. The system of claim 27, wherein the first account and the second account are maintained by a common institution.

30. The system of claim 27, wherein the procurement credential of the first account includes an identifier that is randomly generated by a computer algorithm.

31. The system of claim 27, wherein the procurement credential is valid for non-face-to-face transactions.

32. The system of claim 31, wherein the non-face-to-face transactions are Internet purchases.

33. The system of claim 27, wherein the procurement credential includes a billing address that is different than an actual address of the account holder.

34. The system of claim 33, wherein the billing address is an address for a third party service company.

35. The system of claim 27, wherein the procurement credential of the first account includes an identifier which is a generated name that resides in a media.

36. The system of claim 35, wherein the media can include any one of paper, plastic cards, electronic media, and any storage device.

37. The system of claim 27, wherein the procurement credential includes a depository account number that enables simulation of a check transaction using the first account.

38. The system of claim 26, wherein the second account is an existing credit account.
